(19) United States
(12) Patent Application Publication
(10) Pub. No.: US 2025/0267523 A1
(43) Pub. Date: Aug. 21, 2025

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/197,651

(22) Filed: May 2, 2025

Related U.S. Application Data
(63) Continuation of application No. PCT/JP2023/039400, filed on Nov. 1, 2023.
(60) Provisional application No. 63/421,712, filed on Nov. 2, 2022.

(51) Int. Cl. H04W 36/00; H04W 16/26; H04W 36/08

(52) U.S. Cl. CPC H04W 36/0007; H04W 36/00725; H04W 36/08; H04W 16/26

(57) ABSTRACT

In an aspect, a communication control method is a communication control method to be used in a cellular communication system. The communication control method includes a step of broadcasting, by a relay node, an offset value for a mobile relay node and a step of executing by a user equipment, an intra-frequency cell reselection procedure by using the offset value for a mobile relay node.

### RELATED APPLICATIONS

The present application is a continuation based on PCT Application No. PCT/JP2023/039400, filed on Nov. 1, 2023, which claims the benefit of U.S. Provisional Patent Application No. 63/421,712 filed on Nov. 2, 2022. The content of which is incorporated by reference herein in their entirety.

### TECHNICAL FIELD

The present disclosure relates to a communication control method used in a cellular communication system.

### BACKGROUND

The Third Generation Partnership Project (3GPP) that is a standardization project of a cellular communication system has studied introduction of a new relay node referred to as an Integrated Access and Backhaul (IAB) node (see, for example, Non-Patent Document 1). One or more relay nodes are involved in communication between a base station and a user equipment and perform relay for the communication.

### CITATION LIST

### Non-Patent Literature

Non-Patent Document 1: 3GPP TS 38.300 V17.2.0 (2022-09)

### SUMMARY

In a first aspect, a communication control method is a communication control method to be used in a cellular communication system. The communication control method includes a step of broadcasting, by a relay node, an offset value for a mobile relay node and a step of executing, by a user equipment, an intra-frequency cell reselection procedure by using the offset value for a mobile relay node.

In a second aspect, a communication control method is a communication control method to be used in a cellular communication system. The communication control method includes receiving, by a user equipment, High-Speed Dedicated Network (HSDN) cell information indicating that a cell is an HSDN cell and a mobile relay node cell type indication indicating that the cell is a cell of a mobile relay node from the cell. The communication control method further includes executing, by the user equipment, an inter-frequency cell reselection procedure without regarding a cell as a cell of a lowest priority when the user equipment is in a low-mobility state.

### BRIEF DESCRIPTION OF THE DRAWINGS

FIG. 1 is a diagram illustrating a configuration example of a cellular communication system according to an embodiment.

FIG. 2 is a diagram illustrating a relationship between an IAB node, parent nodes, and child nodes.

FIG. 3 is a diagram illustrating a configuration example of a gNB (base station) according to the embodiment.

FIG. 4 is a diagram illustrating a configuration example of an IAB node (relay node) according to the embodiment.

FIG. 5 is a diagram illustrating a configuration example of a User Equipment (UE) according to the embodiment.

FIG. 6 is a diagram illustrating an example of a protocol stack relating to RRC connection and NAS connection of an IAB-MT.

FIG. 7 is a diagram illustrating an example of a protocol stack relating to an F1-U protocol.

FIG. 8 is a diagram illustrating an example of a protocol stack relating to an F1-C protocol.

FIG. 9 is a diagram illustrating an operation example according to a first embodiment.

FIGS. 10A and 10B are diagrams illustrating an operation example according to the first embodiment.

FIG. 11 is a diagram illustrating an operation example according to a second embodiment.

FIG. 12 is a diagram illustrates scenarios and subcases for cell reselection of the UE.

FIG. 13 is a diagram illustrating a RACH-less handover configuration in MobilityControlInfo that uses information of applicable Timing Advance (TA) and uplink grant.

### DESCRIPTION OF EMBODIMENTS

A cellular communication system according to an embodiment will be described with reference to the drawings. In the description of the drawings, the same or similar parts are denoted by the same or similar reference signs.

### First Embodiment

### Configuration of Cellular Communication System

A configuration example of the cellular communication system according to the embodiment will be described. A cellular communication system 1 according to the embodiment is a 3GPP 5G system. More specifically, a radio access scheme in the cellular communication system 1 is a New Radio (NR) that is a 5G radio access scheme. Note that Long Term Evolution (LTE) may be at least partially applied to the cellular communication system 1. A future cellular communication system such as 6G may be also applied to the cellular communication system 1.

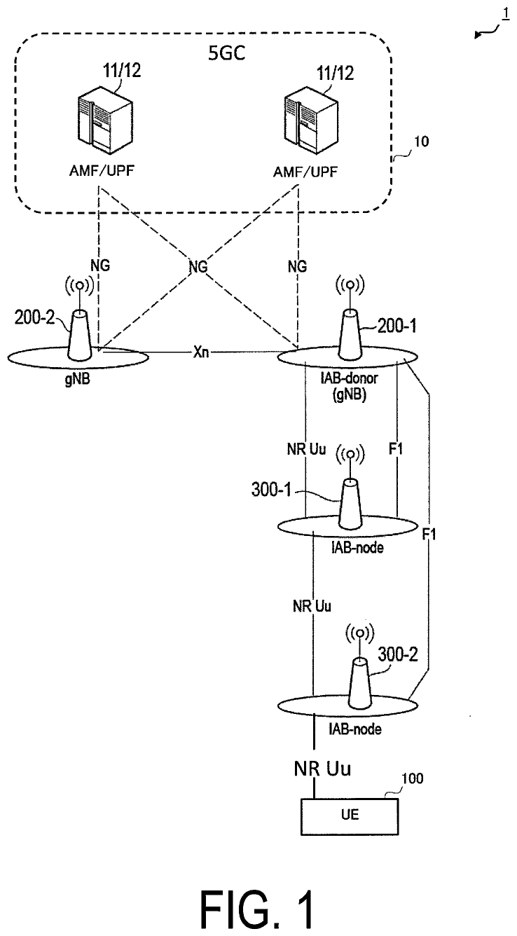

FIG. 1 is a diagram illustrating a configuration example of the cellular communication system 1 according to the embodiment.

As illustrated in FIG. 1, the cellular communication system 1 includes a 5G core network (5GC) 10, a User Equipment (UE) 100, base station apparatuses (hereinafter may be referred to as “base stations”) 200-1 and 200-2, and IAB nodes 300-1 and 300-2. A base station 200 may be referred to as a gNB.

In the following, an example where the base station 200 is an NR base station will be mainly described. However, the base station 200 may be also an LTE base station (i.e., eNB).

Note that, in the following, the base stations 200-1 and 200-2 may be referred to as the gNBs 200 (or the base stations 200), and the IAB nodes 300-1 and 300-2 may be referred to as IAB nodes 300.

The 5GC 10 includes an Access and Mobility Management Function (AMF) 11 and a User Plane Function (UPF) 12. The AMF 11 is an apparatus that performs various mobility controls for the UE 100. The AMF 11 communicates with the UE 100 by using Non-Access Stratum (NAS) signaling to manage information on an area in which the UE 100 exists. The UPF 12 is an apparatus that performs transfer control of user data, and the like.

Each gNB 200 is a fixed wireless communication node and manages one or more cells. The term “cell” is used to indicate a minimum unit of a wireless communication area. The “cell” may be used as a term indicating a function or a resource for performing wireless communication with the UE 100. One cell belongs to one carrier frequency. Hereinafter, a cell and a base station may be used without distinction.

Each gNB 200 is interconnected with the 5GC 10 via an interface referred to as an NG interface. FIG. 1 illustrates two gNBs, that is, the gNB 200-1 and the gNB 200-2 connected to the 5GC 10.

Each gNB 200 may be divided into a central unit (CU) and a distributed unit (DU). The CU and the DU are interconnected via an interface referred to as an F1 interface. An F1 protocol is a communication protocol between the CU and the DU and includes an F1-C protocol that is a control plane protocol, and an F1-U protocol that is a user plane protocol.

The cellular communication system 1 supports IAB that enables wireless relay of NR access by using an NR for backhaul. The donor gNB 200-1 (or a donor node that may be hereinafter referred to as a “donor node”) is a terminal node of the NR backhaul on the network side and is a donor base station having additional functions for supporting IAB. The backhaul is capable of multi-hopping via a plurality of hops (i.e., a plurality of IAB nodes 300).

FIG. 1 illustrates an example where the IAB node 300-1 is wirelessly connected to the donor node 200-1, the IAB node 300-2 is wirelessly connected to the IAB node 300-1, and the F1 protocol is transmitted by two backhaul hops.

The UE 100 is a mobile wireless communication apparatus that performs wireless communication with a cell. The UE 100 may be any apparatus that performs wireless communication with the gNB 200 or the IAB node 300. For example, the UE 100 is a mobile telephone terminal and/or a tablet terminal, a notebook PC, a sensor, an apparatus provided in a sensor, a vehicle, an apparatus provided in a vehicle, an aircraft, or an apparatus provided in an aircraft. The UE 100 is wirelessly connected to the IAB node 300 or the gNB 200 via an access link. FIG. 1 illustrates an example where the UE 100 is wirelessly connected to the IAB node 300-2. The UE 100 indirectly communicates with the donor node 200-1 via the IAB node 300-2 and the IAB node 300-1.

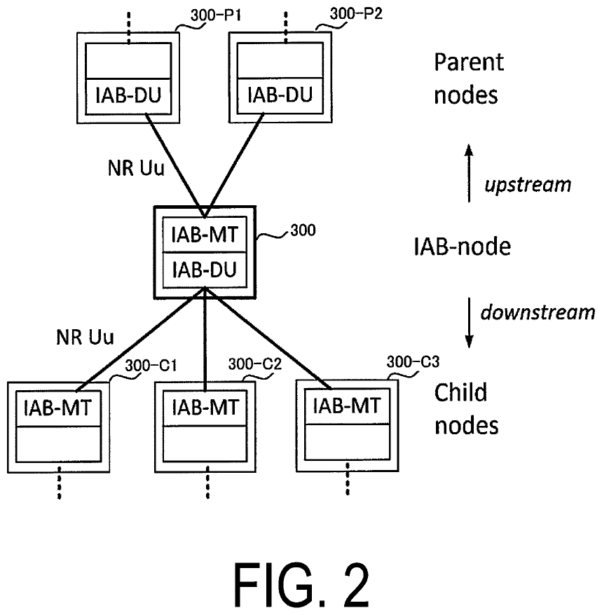

FIG. 2 is a diagram illustrating an example of a relationship between the IAB node 300, parent nodes, and child nodes.

As illustrated in FIG. 2, each IAB node 300 includes an IAB-DU corresponding to a base station function unit, and an IAB-MT (Mobile Termination) corresponding to a user equipment function unit.

Neighboring nodes (i.e., upper nodes) on an NR Uu radio interface of the IAB-MT are referred to as parent nodes. The parent node is a DU of a parent IAB node or the donor node 200. A radio link between the IAB-MT and the parent node is referred to as a backhaul link (BH link). FIG. 2 illustrates an example where the parent nodes of the IAB node 300 are IAB nodes 300-P1 and 300-P2. Note that a direction toward the parent nodes is referred to as upstream. When viewed from the UE 100, the upper node of the UE 100 may correspond to a parent node.

Neighboring nodes (i.e., lower nodes) on the NR access interface of the IAB-DU are referred to as child nodes. The IAB-DU manages the cell similar to the gNB 200. The IAB-DU terminates the NR Uu radio interface to the UE 100 and the lower IAB nodes. The IAB-DU supports the F1 protocol to the CU of the donor node 200-1. FIG. 2 illustrates an example where the child nodes of the IAB node 300 are IAB nodes 300-C1 to 300-C3. However, the child node of the IAB node 300 may also include the UE 100. Note that a direction toward the child nodes is referred to as downstream.

All of the IAB nodes 300 connected to the donor node 200 via one or more hops form a Directed Acyclic Graph (DAG) topology (also referred to as a “topology” hereinafter) that uses the donor node 200 as a root. In this topology, as illustrated in FIG. 2, neighboring nodes on the IAB-DU interface are child nodes, and neighboring nodes on the IAB-MT interface are parent nodes. The donor node 200 centrally performs, for example, resource, topology, and route management of the IAB topology. The donor node 200 is a gNB that provides network access to the UE 100 via a network of backhaul links and access links.

### Configuration of Base Station

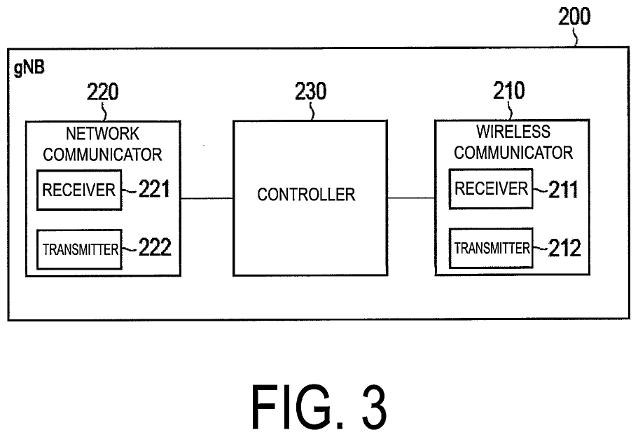

The configuration of the gNB 200 that is a base station according to the embodiment will be described. FIG. 3 is a diagram illustrating a configuration example of the gNB 200. As illustrated in FIG. 3, the gNB 200 includes a wireless communicator 210, a network communicator 220, and a controller 230.

The wireless communicator 210 performs wireless communication with the UE 100 and wireless communication with the IAB node 300. The wireless communicator 210 includes a receiver 211 and a transmitter 212. The receiver 211 performs various types of reception under control of the controller 230. The receiver 211 includes an antenna and converts (down-converts) a radio signal received by the antenna into a baseband signal (reception signal) and outputs the signal to the controller 230. The transmitter 212 performs various types of transmission under the control of the controller 230. The transmitter 212 includes an antenna and converts (up-converts) a baseband signal (transmission signal) output by the controller 230 into a radio signal and transmits the signal from the antenna.

The network communicator 220 performs wired communication (or wireless communication) with the 5GC 10 and wired communication (or wireless communication) with the other neighboring gNBs 200. The network communicator 220 includes a receiver 221 and a transmitter 222. The receiver 221 performs various types of reception under the control of the controller 230. The receiver 221 receives a signal from the outside and outputs the reception signal to the controller 230. The transmitter 222 performs various types of transmission under the control of the controller 230. The transmitter 222 transmits a transmission signal output by the controller 230 to the outside.

The controller 230 performs various types of control in the gNB 200. The controller 230 includes at least one memory and at least one processor electrically connected to the memory. The memory stores a program to be executed by the processor and information to be used for processing by the processor. The processor may include a baseband processor and a

CPU. The baseband processor performs modulation and demodulation, encoding and decoding, and the like of a baseband signal. The CPU executes the program stored in the memory to thereby perform various types of processing. The processor performs processing of layers to be described below. Note that the controller 230 may perform each processing and each operation in the gNB 200 in each embodiment to be described below.

### Configuration of Relay Node

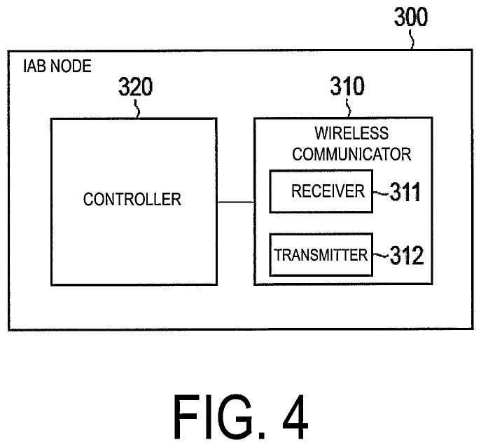

A configuration of the IAB node 300 that is a relay node (or a relay node apparatus that may hereinafter be referred to as a “relay node”) according to the embodiment will be described. FIG. 4 is a diagram illustrating a configuration example of the IAB node 300. As illustrated in FIG. 4, the IAB node 300 includes a wireless communicator 310 and a controller 320. The IAB node 300 may include a plurality of the wireless communicators 310.

The wireless communicator 310 performs wireless communication (BH link) with the gNB 200 and wireless communication (access link) with the UE 100. The wireless communicator 310 for BH link communication and the wireless communicator 310 for access link communication may be provided separately.

The wireless communicator 310 includes a receiver 311 and a transmitter 312. The receiver 311 performs various types of reception under the control of the controller 320. The receiver 311 includes an antenna and converts (down-converts) a radio signal received by the antenna into a baseband signal (reception signal) and outputs the converted signal to the controller 320. The transmitter 312 performs various types of transmission under the control of the controller 320. The transmitter 312 includes an antenna and converts (up-converts) a baseband signal (transmission signal) output by the controller 320 into a radio signal and transmits the converted signal from the antenna.

The controller 320 performs various types of control in the IAB node 300. The controller 320 includes at least one memory and at least one processor electrically connected to the memory. The memory stores a program to be executed by the processor and information to be used for processing by the processor. The processor may include a baseband processor and a CPU. The baseband processor performs modulation and demodulation, encoding and decoding, and the like of a baseband signal. The CPU executes the program stored in the memory to thereby perform various types of processing. The processor performs processing of layers to be described below. Note that the controller 320 may perform each process or each operation in the IAB node 300 in each embodiment to be described below.

### Configuration of User Equipment

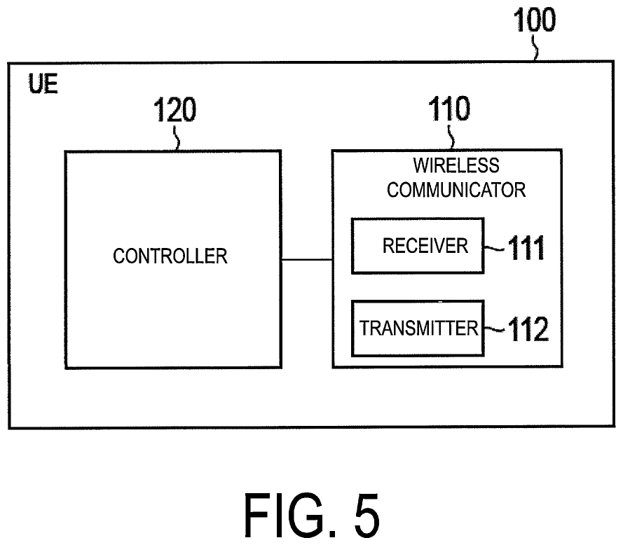

The configuration of the UE 100 that is a user equipment according to the embodiment will be described. FIG. 5 is a diagram illustrating a configuration example of the UE 100. As illustrated in FIG. 5, the UE 100 includes a wireless communicator 110 and a controller 120.

The wireless communicator 110 performs wireless communication in an access link, that is, wireless communication with the gNB 200 and wireless communication with the IAB node 300. The wireless communicator 110 may also perform wireless communication in a side link, that is, wireless communication with the other UEs 100. The wireless communicator 110 includes a receiver 111 and a transmitter 112. The receiver 111 performs various types of reception under the control of the controller 120. The receiver 111 includes an antenna and converts (down-converts) a radio signal received by the antenna into a baseband signal (reception signal) and outputs the converted signal to the controller 120. The transmitter 112 performs various types of transmission under control of the controller 120. The transmitter 112 includes an antenna and converts (up-converts) a baseband signal (transmission signal) output by the controller 120 into a radio signal and transmits the converted signal from the antenna.

The controller 120 performs various types of control in the UE 100. The controller 120 includes at least one memory and at least one processor electrically connected to the memory. The memory stores a program to be executed by the processor and information to be used for processing by the processor. The processor may include a baseband processor and a CPU. The baseband processor performs modulation and demodulation, encoding and decoding, and the like of a baseband signal. The CPU executes the program stored in the memory to thereby perform various types of processing. The processor performs processing of layers to be described below. Note that the controller 120 may perform each process in the UE 100 in each embodiment to be described below.

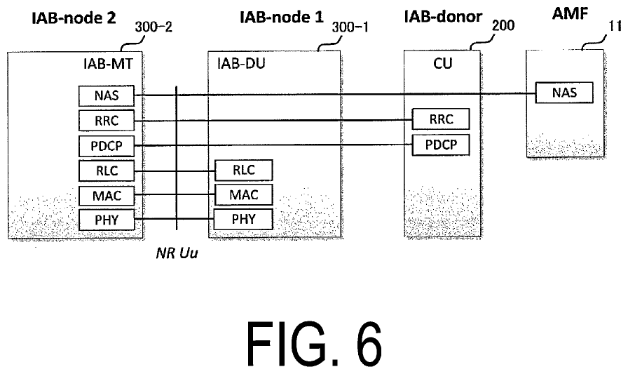

Configuration of Protocol Stack A configuration of a protocol stack according to the embodiment will be described. FIG. 6 is a diagram illustrating an example of a protocol stack relating to RRC connection and NAS connection of the IAB-MT.

As illustrated in FIG. 6, the IAB-MT of the IAB node 300-2 includes a physical (PHY) layer, a Medium Access Control (MAC) layer, a Radio Link Control (RLC) layer, a Packet Data Convergence Protocol (PDCP) layer, a Radio Resource Control (RRC) layer, and a Non-Access Stratum (NAS) layer.

The PHY layer performs encoding and decoding, modulation and demodulation, antenna mapping and demapping, and resource mapping and demapping. Data and control information are transmitted between the PHY layer of the IAB-MT of the IAB node 300-2 and the PHY layer of the IAB-DU of the IAB node 300-1 via a physical channel.

The MAC layer performs priority control of data, retransmission processing through Hybrid Automatic Repeat reQuest (HARQ), a random access procedure, and the like. Data and control information are transmitted between the MAC layer of the IAB-MT of the IAB node 300-2 and the MAC layer of the IAB-DU of the IAB node 300-1 via a transport channel. The MAC layer of the IAB-DU includes a scheduler. The scheduler determines a transport format (a transport block size and a Modulation and Coding Scheme (MCS)) and assigned resource blocks for an uplink and a downlink.

The RLC layer transmits data to the RLC layer on the reception side by using functions of the MAC layer and the PHY layer. Data and control information are transmitted between the RLC layer of the IAB-MT of the IAB node 300-2 and the RLC layer of the IAB-DU of the IAB node 300-1 via a logical channel.

The PDCP layer performs header compression/decompression and encryption/decryption. Data and control information are transmitted between the PDCP layer of the IAB-MT of the IAB node 300-2 and the PDCP layer of the donor node 200 via a radio bearer.

The RRC layer controls a logical channel, a transport channel, and a physical channel in response to establishment, re-establishment, and release of a radio bearer. RRC signaling for various settings is transmitted between the RRC layer of the IAB-MT of the IAB node 300-2 and the RRC layer of the donor node 200. When RRC connection is established with the donor node 200, the IAB-MT is in an RRC connected state. When no RRC connection is established with the donor node 200, the IAB-MT is in an RRC idle state.

The NAS layer positioned upper than the RRC layer performs session management, mobility management, and the like. NAS signaling is transmitted between the NAS layer of the IAB-MT of the IAB node 300-2 and the AMF 11.

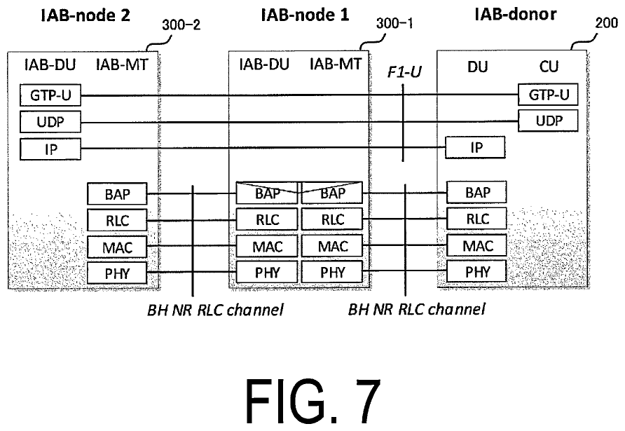

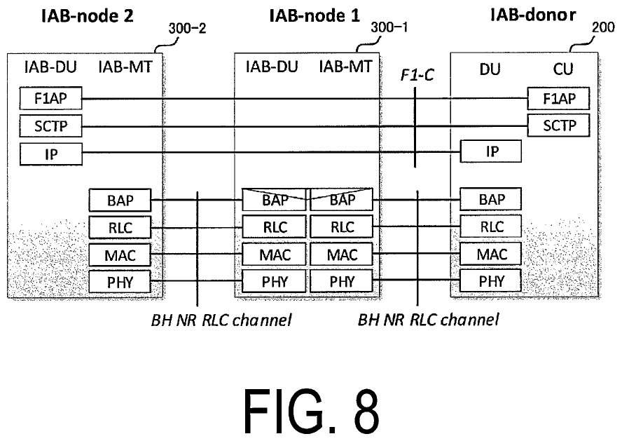

FIG. 7 is a diagram illustrating a protocol stack relating to the F1-U protocol. FIG. 8 is a diagram illustrating a protocol stack relating to the F1-C protocol. Here, an example where the donor node 200 is divided into a CU and a DU will be described.

As illustrated in FIG. 7, the IAB-MT of the IAB node 300-2, the IAB-DU of the IAB node 300-1, the IAB-MT of the IAB node 300-1, and the DU of the donor node 200 each include a Backhaul Adaptation Protocol (BAP) layer as an upper layer of the RLC layer. The BAP layer is a layer for performing routing processing and bearer mapping/demapping processing. In the backhaul, the IP layer is transmitted via the BAP layer, enabling multi-hop routing.

In each backhaul link, a Protocol Data Unit (PDU) of the BAP layer is transmitted by a backhaul RLC channel (BH NR RLC channel). Configuring a plurality of backhaul RLC channels in each BH link traffic enables prioritization and quality of service (QOS) control. The BAP PDU is associated with the backhaul RLC channel by the BAP layer of each IAB node 300 and the BAP layer of the donor node 200.

As illustrated in FIG. 8, the protocol stack of the F1-C protocol includes an F1AP layer and an SCTP layer instead of a GTP-U layer and a UDP layer illustrated in FIG. 7.

Note that, in the following, processing or operations performed in the IAB-DU and the IAB-MT of the IAB may be simply described as processing or operations of the “IAB”. For example, transmission of a message of the BAP layer from the IAB-DU of the IAB node 300-1 to the IAB-MT of the IAB node 300-2 will be described as transmission of the message from the IAB node 300-1 to the IAB node 300-2. Processing or operations of the DU or CU of the donor node 200 may be also described simply as processing or operations of the “donor node.”

An upstream direction and an uplink (UL) direction may be used without distinction. A downstream direction and a downlink (DL) direction may be used without distinction.

### Mobile IAB Node

At present, 3GPP has started to study the introduction of a mobile IAB node. The mobile IAB node is, for example, an IAB node that is moving. The mobile IAB node may be a movable IAB node. The mobile IAB node may be an IAB node that has capability to move. The mobile IAB node may be an IAB node that is currently stationary but is certain to move in the future (or is expected to move in the future).

The mobile IAB node allows, for example, the UE 100 subordinate to the mobile IAB node to receive services from the mobile IAB node while moving as the mobile IAB node moves. For example, a case is assumed where a user (or the UE 100) who is getting on a vehicle receives services via a mobile IAB node installed in the vehicle.

On the other hand, in contrast to the mobile IAB node, an IAB node that does not move also exists. Such an IAB node may be referred to as an intermediate IAB node. The intermediate IAB node is, for example, an IAB node that does not move. The intermediate IAB node may be a stationary IAB node. The intermediate IAB node may be a stationary IAB node. The intermediate IAB node may be an IAB node that is stationary (or does not move) in a state where the intermediate IAB node is left installed at the installation location. The intermediate IAB node may be a stationary IAB node that does not migrate and is stationary. The intermediate IAB node may be a fixed IAB node.

The mobile IAB node can be also connected to the intermediate IAB node. The mobile IAB node can be also connected to the donor node 200. The mobile IAB node can also change a connection destination by moving (migration or handover). A connection source may be the intermediate IAB node. The connection source may be the donor node 200. The connection destination may be the intermediate IAB node. The connection destination may be the donor node 200.

Note that, in the following, migration of the mobile IAB node and handover of the mobile IAB node may be used without distinction.

In the following, the mobile IAB node may be a “mobile IAB node”. The mobile IAB node may be a “migrating IAB node”. In either case, the node may be referred to as a mobile IAB node.

### Cell Reselection Procedure

The cell reselection procedure according to the first embodiment will be described.

The UE 100 in the RRC idle state or the RRC inactive state performs the cell reselection procedure to migrate from a current serving cell to a neighboring cell as the UE 100 migrates. More specifically, the UE 100 specifies a neighboring cell on which the UE 100 itself needs to camp by the cell reselection procedure and reselects the specified neighboring cell. Frequencies (carrier frequencies) that are the same between the current serving cell and the neighboring cell will be referred to as intra-frequencies, and frequencies (carrier frequencies) that are different between the current serving cell and the neighboring cell will be referred to as inter-frequencies. The current serving cell and the neighboring cell may be managed by the same gNB 200. The current serving cell and the neighboring cell may be managed by the gNBs 200 different from each other.

The cell reselection procedure includes an intra-frequency cell reselection procedure and an inter-frequency cell reselection procedure.

In the intra-frequency cell reselection procedure, cell reselection is performed based on ranking of cells. In the intra-frequency cell reselection procedure, for example, following processing is performed.

First, the UE 100 performs measurement processing of measuring radio quality of each of the serving cell and the neighboring cell. More specifically, the UE 100 measures RSRP and RSRQ of a Cell Defining-Synchronization Signal and PBCH block (CD-SSB)) of each of the serving cell and the neighboring cell.

Second, the UE 100 calculates a ranking criterion (Rs) for the serving cell and a ranking criterion (Rn) for the neighboring cell for all cells satisfying a cell selection criterion S. Rs and Rn are calculated by using the following equations.

Rₛ=Q_{meas,s}+Q_{hyst}−Qoffsetₜₑₘₚ (1)

Rn=Q_{meas,n}−Qoffset−Qoffsetₜₑₘₚ (2)

In Equation (1), Q_{meas,s} represents Reference Signal Received Power (RSRP) (measurement value) for the serving cell. In Equation (2), Q_{meas,n} represents RSRP (measurement value) for the neighboring cell. Qoffset is an offset value for adjusting RSRP. Qoffsetₜₑₘₚ is an offset to be temporarily used.

The UE 100 basically reselects a cell of a highest rank from the two ranking criteria Rs and Rn.

As expressed in Equation (2), an offset value (Qoffset) is used for Rn. Qoffset is provided from the gNB 200 to the UE 100 by using broadcast signaling (e.g., System Information Block (SIB)). Qoffset can be adjusted per frequency or per cell. A network side can control easiness of reselection of the serving cell and the neighboring cell by adjusting Qoffset.

Note that the cell selection criterion S is a criterion for selecting a cell whose RSRP exceeds an RSRP minimum required level and whose RSRQ exceeds an RSRQ minimum required level.

On the other hand, according to the inter-frequency cell reselection procedure, cell reselection is performed based on an absolute frequency priority. The frequency priority is provided from the gNB 200 to the UE 100 by broadcast signaling (e.g., system information block) or dedicated signaling (e.g., RRCRelease message). In the inter-frequency cell reselection procedure, for example, the following processing is performed.

First, the UE 100 performs measurement processing of measuring radio quality of each of the serving cell and the neighboring cell. More specifically, the UE 100 measures always the radio quality for a frequency having a priority higher than the priority of the frequency of the current serving cell. For a frequency having a priority equal to or a priority lower than the priority of the frequency of the current serving cell, when the radio quality of the current serving cell is lower than predetermined quality, the UE 100 measures the radio quality for a frequency having the equal priority or the lower frequency.

Second, based on the measurement result, the UE 100 performs cell reselection processing of reselecting a cell on which the UE 100 itself camps. More specifically, the UE 100 may perform the cell reselection to the neighboring cell when the priority of the frequency of the neighboring cell is higher than the priority of the current serving cell and when the neighboring cell satisfies a predetermined quality criterion (i.e., minimum quality criterion) for a predetermined period of time. When the priorities of the frequencies of the neighboring cells are the same as the priority of the current serving cell, the UE 100 may rank the radio qualities of the neighboring cells and perform cell reselection for the neighboring cells ranked higher than the ranking of the current serving cell for a predetermined period of time. When the priorities of the frequencies of the neighboring cells are lower than the priority of the current serving cell, the radio quality of the current serving cell is lower than a certain threshold value, and the radio qualities of the neighboring cells are continuously higher than another threshold value for the predetermined period of time, the UE 100 may perform cell reselection for the neighboring cell.

The above-described example has been described as an example where the UE 100 performs the cell reselection procedure. However, the IAB-MT of the IAB node 300 can also execute the cell reselection procedure.

### Communication Control Method According to First Embodiment

A communication control method according to the first embodiment will be described. In the first embodiment, an intra-frequency cell reselection procedure of a mobile IAB node will be described.

The mobile IAB node can broadcast a mobile-IAB cell type indication (or mobile relay node cell type indication) indicating that the mobile IAB node itself is a mobile IAB node. The mobile-IAB cell type indication makes it possible to, for example, assist movement of the UE 100 in an RRC idle state or an RRC inactive state. The mobile-IAB cell type indication is, for example, one-bit information. Together with (or instead of) the mobile-IAB cell type indication, movement speed information indicating a movement speed of the mobile IAB node may be broadcast. As described above, when the mobile IAB node broadcasts the mobile-IAB cell type indication (and/or the movement speed information), the UE 100 having received the information can recognize that the cell having broadcast the information is the cell of the mobile IAB node.

On the other hand, according to the intra-frequency cell reselection procedure, reselection is performed based on ranking that uses Equation (1) and Equation (2) as described above. Here, a case is assumed where the intra-frequency cell reselection procedure is applied to the mobile IAB node. Even in such a case, by, for example, adjusting Qoffset in Equation (2), the network side can control easiness of reselection of the cell of the mobile IAB node (hereinafter, the cell will be referred to as a “mobile IAB cell”).

However, there is only one type of Qoffset. In a non-mobile IAB node, when the mobile IAB moves into a cell of the non-mobile IAB node (hereinafter, the cell may be referred to as a “non-mobile IAB cell”, the “non-mobile IAB cell” may include cells provided by fixed (stationary) IAB nodes, and the “non-mobile IAB cell” may include a cell (such as a macrocell) provided by a conventional base station), Qoffset may be changed for the mobile IAB node and an SIB may be also updated in response to the change. In the non-mobile IAB node, when the mobile IAB node moves out of the cell of the non-mobile IA node, Qoffset may be undone, and the SIB may be updated again in response to the change. As described above, the non-mobile IAB node may update the SIB each time the mobile IAB node moves into and moves out of the non-mobile IAB cell. The mobile IAB node may also adjust Qoffset for the subordinate UE 100 and update the SIB broadcast by the mobile IAB node each time the mobile IAB node moves in and moves out of the non-mobile IAB cell.

In the first embodiment, an update frequency of an SIB is suppressed.

Hence, in the first embodiment, first, the relay node (e.g., IAB node 300) broadcasts the offset value for the mobile relay node (e.g., an offset value for the mobile IAB node). Second, the user equipment (e.g., UE 100) executes an intra-frequency cell reselection procedure by using the offset value for the mobile relay node.

As described above, the offset value for the mobile IAB node is broadcast from the IAB node 300, and the intra-frequency cell reselection procedure is executed by the UE 100 by using the offset value for the mobile IAB node. Hence, the network side does not need to adjust Qoffset for the mobile IAB node by using the offset value for the mobile IAB node. Accordingly, the update frequency of the SIB by adjusting Qoffset can be suppressed.

Note that the non-mobile IAB node is, for example, a node other than the mobile IAB node. The non-mobile IAB node may be an intermediate IAB node. The non-mobile IAB node may be the donor node 200 (or the gNB 200).

### Operation Example According to First Embodiment

An operation example according to the first embodiment will be described.

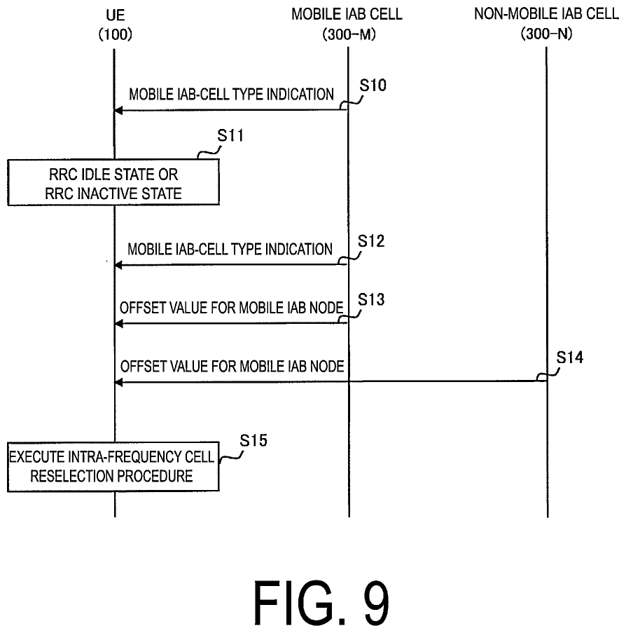

FIG. 9 is a diagram illustrating an operation example according to the first embodiment.

As illustrated in FIG. 9, a mobile IAB node 300-M broadcasts the mobile-IAB cell type indication in step S10. In this regard, a non-mobile IAB cell 300-N does not broadcast the mobile-IAB cell type indication.

In step S11, the UE 100 transitions to the RRC idle state or the RRC inactive state.

In step S12, the UE 100 receives the mobile-IAB cell type indication (and/or movement speed information) broadcast from the mobile IAB cell 300-M. The UE 100 may receive the mobile-IAB cell type indication when starting the intra-frequency cell reselection procedure and performing measurement processing on the serving cell and neighboring cells. The UE 100 can determine whether the serving cell and the neighboring cell are mobile IAB nodes according to whether the UE 100 has received the IAB cell type indication.

In step S13, the mobile IAB node 300-M broadcasts the offset value for the mobile IAB node. The offset value for the mobile IAB node is, for example, an offset value for adjusting RSRP (measurement value) to be used for a ranking criterion R (Rs and Rn).

First, the mobile IAB cell 300-M may broadcast the offset value for the mobile IAB node by using an SIB. The mobile IAB cell 300-M may transmit the offset value for the mobile IAB node by using dedicated signaling (e.g., RRCRelease message).

Second, the mobile IAB cell 300-M may broadcast an offset value for the mobile IAB node such that RSRP of the mobile IAB cell 300-M is higher than RSRP of the non-mobile IAB cell 300-N. Such an offset value enables the network to allow the UE 100 having camped on the mobile IAB cell 300-M to continue camping on the mobile IAB cell 300-M. The mobile IAB cell 300-M may broadcast the offset value for the mobile IAB node such that the RSRP of the mobile IAB cell 300-M is lower than the RSRP of the non-mobile IAB cell 300-N.

In step S14, the non-mobile IAB node 300-N broadcasts the offset value for the mobile IAB node.

First, similar to the mobile IAB cell 300-M, the non-mobile IAB cell 300-N may also broadcast the offset value by using an SIB or transmit the offset value by using dedicated signaling (e.g., RRCRelease message).

Second, the non-mobile IAB cell 300-N may broadcast such an offset value for the mobile IAB node that the RSRP of the mobile IAB cell 300-M (neighboring cell) is lower than the RSRP of the non-mobile IAB cell 300-N. The non-mobile IAB cell 300-N may broadcast such an offset value for the mobile IAB node that the RSRP of the mobile IAB cell 300-M (neighboring cell) is higher than that of the non-mobile IAB cell 300-N.

As illustrated in step S13 and step S14, different offset values may be broadcast in response to whether the cell of the IAB node 300 is the cell of the mobile IAB node (i.e., mobile IAB cell 300-M) or the cell other than the mobile IAB node (i.e., non-mobile IAB cell 300-N).

In step S15, the UE 100 executes the intra-frequency cell reselection procedure. When starting executing the procedure in step S12, the UE 100 may calculate the ranking criterion R (Rs and Rn) of the procedure in step S15. The UE 100 uses the offset value for the mobile IAB node, for example, as follows.

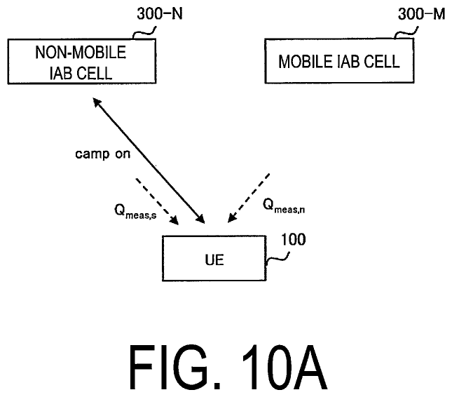

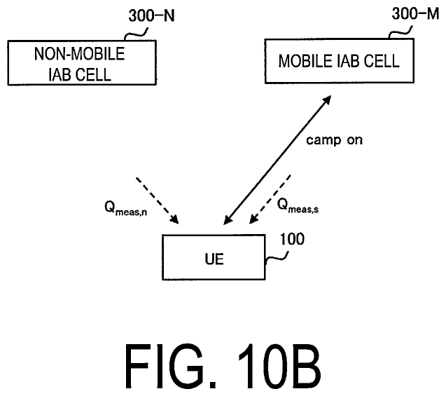

First, this is an operation at a time when the UE 100 is camping on the non-mobile IAB cell 300-N(i.e., the mobile IAB cell 300-M is a neighboring cell). FIG. 10A illustrates an operation example of such a case.

That is, when camping on the non-mobile IAB cell 300-N, the UE 100 subtracts the offset value for the mobile IAB node from (or adds the offset value for the mobile IAB node that is a minus offset value to) an RSRP measurement value (Q_{meas,n}) only for the mobile IAB cell 300-M (neighboring cell) in the ranking criterion Rn for the neighboring cell.

Thus, for example, the network side can perform control such that the UE 100 camping on the non-mobile IAB cell 300-N is less likely to reselect the mobile IAB cell 300-M.

Note that the operation may be executed when a mobility state of the UE 100 is a low-mobility state (a “normal-mobility state” or a “medium-mobility state”). This is because the UE 100 is camping on the non-mobile IAB cell 300-N and therefore is more likely to be in a low-mobility state than a time when the UE 100 is camping on the mobile IAB cell 300-M.

As described above, when camping on the non-mobile IAB cell 300-N, the UE 100 subtracts the offset value for the mobile IAB node from the RSRP of the mobile IAB cell 300-M.

Second, this is the operation at a time when the UE 100 is camping on the mobile IAB cell 300-M (i.e., the mobile IAB cell 300-M is the serving cell). FIG. 10B illustrates an operation example of such a case.

That is, when camping on the mobile IAB cell 300-M, the UE 100 adds the offset value for the mobile IAB node to (or subtracts the offset value for the mobile IAB node at a time when the offset value is a minus offset value to) an RSRP measurement value (Q_{meas,s}) for the serving cell in the ranking criterion Rn for the serving cell.

Thus, for example, the network side can perform control such that the UE 100 camping on the mobile IAB cell 300-M continues reselecting the mobile IAB cell 300-M.

As described above, when camping on the mobile IAB cell 300-M, the UE 100 adds the offset value for the mobile IAB node to the RSRP of the mobile IAB cell 300-M.

Note that, when the UE 100 is camping on the mobile IAB cell 300-M, if the neighboring cell is not the mobile IAB cell 300-M (i.e., if the neighboring cell is the non-mobile IAB cell 300-N), the UE 100 may execute the operation. On the other hand, when the UE 100 is camping on the mobile IAB cell 300-M, if the neighboring cell is the mobile IAB cell 300-M, the UE 100 may execute the intra-frequency cell reselection procedure (i.e., calculate the ranking criterion R) without using the offset value for the mobile IAB node. For example, considering a scenario that the intra-frequency cell reselection procedure is executed between a plurality of the mobile IAB cells 300-M, if the offset value for the mobile IAB node is not used between the mobile IAB cells 300-M, the UE 100 can more easily reselect the mobile IAB cell 300-M.

When camping on the mobile IAB cell 300-M, the UE 100 may subtract the offset value for the mobile IAB node from (or add the offset value for the mobile IAB node at a time when the offset value is a minus offset value to) the RSRP measurement value (Q_{meas,n}) for the neighboring cell in the ranking criterion Rn for the neighboring cell instead of adding the offset value for the mobile IAB node to the RSRP measurement value (Q_{meas,s}) for the serving cell.

The above-described operations at the time when the UE 100 is camping on the mobile IAB cell 300-M may be performed when the UE 100 is in a high-mobility state. Because the UE 100 is on-board with the mobile IAB cell 300-M, the UE 100 is more likely to be in a high-mobility state than a time when the UE 100 camps on the non-mobile IAB cell 300-N.

The gNB 200 may configure for the UE 100 how the offset value for the mobile IAB node needs to be applied. For example, the gNB 200 may perform the following configuration in addition to the above-described example. That is, when the gNB 200 is in the normal-mobility state, the gNB 200 may be configured to subtract the offset value for the mobile IAB node from (or add the offset value for the mobile IAB node at a time when the offset value is a minus offset value to) the RSRP measurement value (Q_{meas,n}) only for the mobile IAB cell 300-M (neighboring cell). When the gNB 200 is in the medium-mobility state or the high-mobility state, the gNB 200 may be configured to add the offset value for the mobile IAB node to the RSRP measurement value (Q_{meas,s}) for the serving cell. The gNB 200 may be configured to subtract the offset value for the mobile IAB node from (or add the offset value for the mobile IAB node at a time when the offset value is a minus offset value to) the RSRP measurement value (Q_{meas,n}) for the neighboring cell in the ranking criterion Rn for the neighboring cell instead of adding the offset value.

### Other Operation Example 1 According to First Embodiment

Although the case where the offset value for the mobile IAB node is used for the ranking criterion R (Rs and Rs) of the intra-frequency cell reselection procedure has been described in the first embodiment, the present disclosure is not limited thereto.

First, the offset value for the mobile IAB node may be used for the cell selection criterion S of the cell selection procedure. As described above, according to the cell selection criterion S, RSRP is compared with the RSRP minimum required level. The offset value for the mobile IAB node is applied to the RSRP. Similar to the first embodiment, the cell selection criterion S may be determined by adding or subtracting the offset value for the mobile IAB node in response to whether a measurement target cell is the mobile IAB cell 300-M or the non-mobile IAB cell 300-N.

Second, the offset value for the mobile IAB node may be used for measurement processing of inter-frequency cell reselection. For example, upon comparison between the measured RSRP and the threshold value, the offset value for the mobile IAB node is applied to the RSRP. Similar to the first embodiment, the offset value for the mobile IAB node is added to or subtracted from the RSRP in response to whether the measurement target cell is the mobile IAB cell 300-M or the non-mobile IAB cell 300-N.

Other Operation Example 2 according to First Embodiment

In the first embodiment, addition and subtraction of the offset value for the mobile IAB node to and from RSRP may be reversed. When, for example, camping on the non-mobile IAB cell 300-N, the UE 100 may add the offset value for the mobile IAB node to (or subtract the offset value for the mobile IAB node at a time when the offset value is a minus offset value from) the RSRP measurement value (Q_{meas,n}) only for the mobile IAB cell 300-M (neighboring cell). When, for example, camping on the mobile IAB cell 300-M, the UE 100 may subtract the offset value for the mobile IAB node from (or add the offset value for the mobile IAB node at a time when the offset value is a minus offset value to) the RSRP measurement value (Q_{meas,n}) for the serving cell.

### Second Embodiment

A second embodiment will be described. The inter-frequency cell reselection procedure will be described in the second embodiment.

As the inter-frequency cell reselection procedure in the mobile IAB cell 300-M, a procedure that uses an existing frequency priority can be used.

That is, the mobile IAB cell 300-M makes the frequency priority of the frequency to be used by the mobile IAB cell 300-M itself higher than the frequency priority of the frequency to be used by the non-mobile IAB cell 300-N. When the mobile IAB cell 300-M broadcasts the frequency priority, the UE 100 having camped on the mobile IAB cell 300-M is less likely to reselect the non-mobile IAB cell 300-N. On the other hand, the non-mobile IAB cell 300-N makes the frequency priority of the frequency to be used by the mobile IAB cell 300-M itself lower than the frequency priority of the frequency to be used by the non-mobile IAB cell 300-N. When the non-mobile IAB cell 300-N broadcasts the frequency priority, the UE 100 having camped on the non-mobile IAB cell 300-N more easily reselects the mobile IAB cell 300-M.

On the other hand, 3GPP defines a High Speed Dedicated Network (HSDN) (e.g., 3GPP TS 38.304 V17. 2.0 (2022 to 09)). In the HSDN, there are cells called High Speed Dedicated Network Cells (HSDN cells). The HSDN cell broadcasts HSDN cell information (hsdn-cell) indicating that the HSDN cell itself is the HSDN. The UE 100 in the high-mobility state may regard the HSDN cell as a cell of the highest priority. On the other hand, the UE 100 that is not in the high-mobility state may regard the HSDN cell as a cell of the lowest priority. For example, the UE 100 that moves with a high-speed railway can more preferentially reselect HSDN cells installed along a railway track over other cells. Accordingly, the HSDN can appropriately support communication with the UE in the high-mobility state.

A case is assumed where the HSDN is applied to the mobile IAB cell 300-M. In this case, the mobile IAB cell 300-M broadcasts HSDN cell information (hsdn-cell). The UE 100 having received the HSDN cell information can regard the mobile IAB cell as a cell of the highest priority when the UE 100 itself is in the high-mobility state. On the other hand, the UE 100 having received the HSDN cell information can regard the mobile IAB cell as the cell of the lowest priority when the UE 100 itself is in the low-mobility state.

However, even when the UE 100 itself is in the low-mobility state, regarding the mobile IAB cell 300-M as the cell of the lowest priority may not allow the UE 100 to reselect the mobile IAB cell 300-M in the inter-frequency cell reselection procedure.

Hence, in the second embodiment, first, a user equipment (e.g., UE 100) receives HSDN cell information indicating that a cell is a High-Speed Dedicated Network (HSDN) cell and a mobile relay node cell type indication (e.g., mobile-IAB cell type indication) indicating that the cell is a cell of a mobile relay node from the cell. Second, the user equipment executes the inter-frequency cell reselection procedure without regarding the cell as the cell of the lowest priority when user equipment is in the low-mobility state.

This causes the UE 100 having received the HSDN cell information and the mobile-IAB cell type indication even in the low-mobility state not to regard the mobile IAB cell as the cell of the lowest priority. Consequently, the UE 100 can appropriately reselect the mobile IAB cell in the inter-frequency cell reselection procedure.

### Operation Example According to Second Embodiment

An operation example according to the second embodiment will be described.

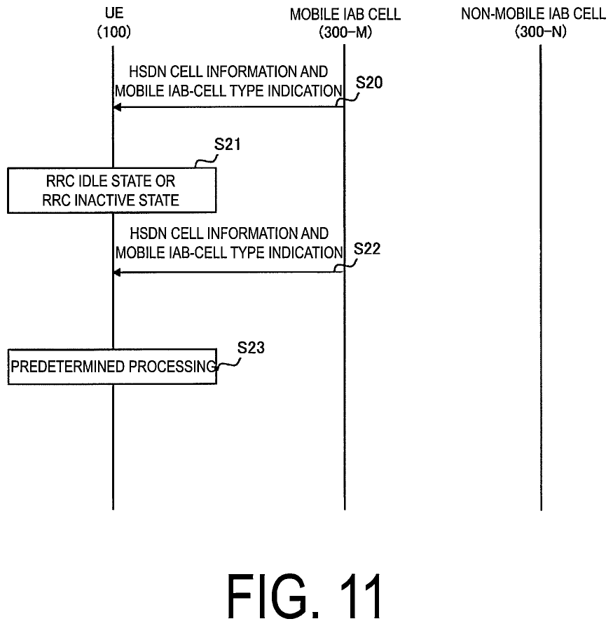

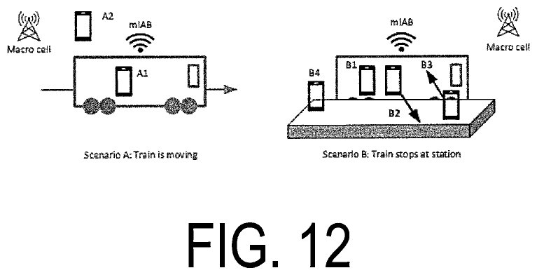

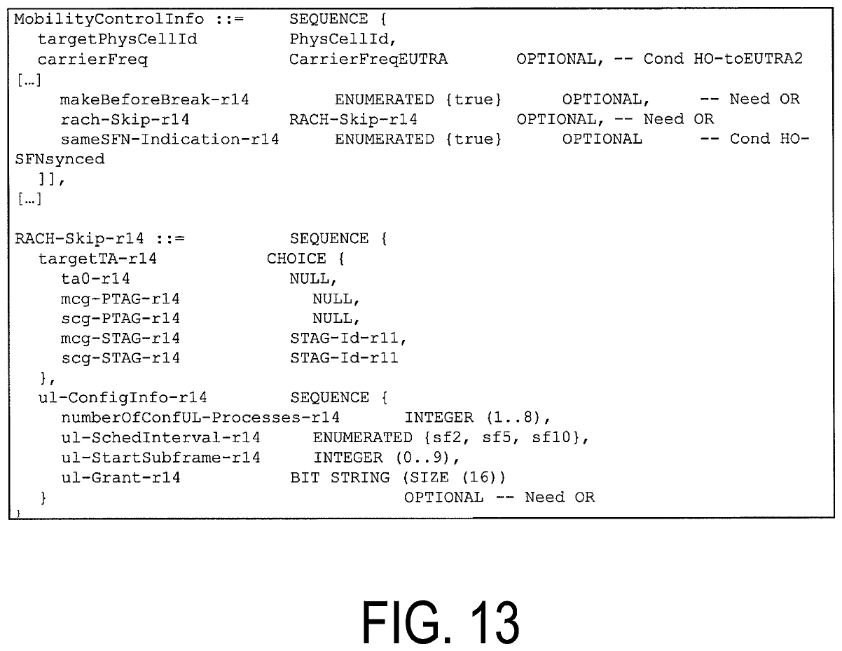

FIG. 11 is a diagram illustrating the operation example according to the second embodiment.

As illustrated in FIG. 11, in step S20, the mobile IAB cell 300-M broadcasts HSDN cell information and a mobile-IAB cell type indication. The mobile IAB cell 300-M may broadcast the HSDN cell information and the mobile-IAB cell type indication by using an SIB. The non-mobile IAB cell 300-N does not broadcast at least the mobile-IAB cell type indication. The non-mobile IAB cell 300-N may broadcast the HSDN cell information.

In step S21, the UE 100 transitions to the RRC idle state or the RRC inactive state.

In step S22, the UE 100 receives the HSDN cell information and the mobile-IAB cell type indication (and/or movement speed information) broadcast from the mobile IAB cell 300-M. The UE 100 may start the inter-frequency cell reselection procedure and receive the HSDN cell information and the mobile-IAB cell type indication at the time of measurement processing. The UE 100 can recognize whether each cell is the mobile IAB cell 300-M or the non-mobile IAB cell 300-N according to whether the UE 100 has received the mobile-IAB cell type indication.

In step S23, the UE 100 having received the HSDN cell information and the mobile-IAB cell type indication performs predetermined processing. More specifically, the predetermined processing is as follows.

That is, if the UE 100 is in the high-mobility state, the UE 100 regards the cell having transmitted the HSDN cell information and the mobile-IAB cell type indication as a cell of the highest priority. On the other hand, if the UE 100 is in the low-mobility state (the “normal-mobility state” or the “medium-mobility state”), the UE 100 does not regard the cell having transmitted the HSDN cell information and the mobile-IAB cell type indication as a cell of the lowest priority. In this case, the UE 100 executes the inter-frequency cell reselection procedure by using a frequency priority provided (by using, an SIB, an RRCRelease message, or the like) from the cell.

Note that the UE 100 may determine a mobility state by using a speed sensor or a Global Navigation Satellite System (GNSS) receiver.

### OTHER EMBODIMENTS

The operation flows described above can be separately and independently implemented and also be implemented in combination of two or more of the operation flows. For example, part of steps of one operation flow may be added to another operation flow or part of steps of one operation flow may be replaced with part of steps of another operation flow. In each flow, all steps do not need to be necessarily performed, and only part of the steps may be performed.

Although the example where the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

Although the term “network node” mainly means a base station, it may also mean an apparatus of a core network or part (a CU, a DU or an RU) of a base station.

A program causing a computer to execute each processing performed by the UE 100 or the gNB 200 may be provided. The program may be recorded in a computer readable medium. Use of the computer readable medium enables the program to be installed on a computer. Here, the computer readable medium on which the program has been recorded may be a non-transitory recording medium. The non-transitory recording medium is not particularly limited and may be, for example, a recording medium such as a CD-ROM or a DVD-ROM.

Circuits for executing each processing performed by the UE 100 or the gNB 200 may be integrated, and at least part of the UE 100 and the gNB 200 may be implemented as a semiconductor integrated circuit (a chipset or a System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on/in response to” means both “only depending on/in response to” and “at least partially depending on/in response to”. The terms “include,” “comprise” and variations thereof do not mean “include only items stated” but instead mean “may include only items stated” or “may include not only the items stated but also other items”.

The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. The respective embodiments, the respective operation examples, or the respective processing may be combined as appropriate without contradicting each other.

### First Supplementary Note

### Supplementary Note 1

A communication control method to be used in a cellular communication system including: a step of broadcasting, by a relay node, an offset value for a mobile relay node; and a step of executing, by a user equipment, an intra-frequency cell reselection procedure by using the offset value for a mobile relay node.

### Supplementary Note 2

The communication control method according to Supplementary Note 1, wherein the step of broadcasting includes a step of broadcasting, by the relay node, in response to whether the relay node is a mobile relay node or a relay node other than the mobile relay node, an offset value for a mobile relay node different from the offset value for a mobile relay node.

### Supplementary Note 3

The communication control method according to Supplementary Note 1 or Supplementary Note 2, wherein the step of executing includes a step of changing, by the user equipment, a method of applying the offset value for a mobile relay node in response to whether a serving cell and a neighboring cell are a cell of a mobile relay node.

### Supplementary Note 4

The communication control method according to any one of Supplementary Note 1 to Supplementary Note 3, wherein
the step of changing includes
by the user equipment, a step of subtracting the offset value for a mobile relay node from reference signal received power for the cell of the mobile relay node when the user equipment is camping on a cell of the relay node other than the mobile relay node and
a step of adding the offset value for a mobile relay node to the reference signal received power for the cell of the mobile relay node when the user equipment is camping on the cell of the mobile relay node.

### Supplementary Note 5

The communication control method according to any one of Supplementary Note 1 to Supplementary Note 4, wherein the step of adding includes a step of subtracting, by the user equipment, the offset value for a mobile relay node from reference signal received power for the cell of the relay node other than the mobile relay node instead of adding the offset value for a mobile relay node.

### Supplementary Note 6

The communication control method according to any one of Supplementary Note 1 to Supplementary Note 5, wherein the step of changing executes, by the user equipment, the intra-frequency cell reselection procedure without using the offset value for a mobile relay node when the user equipment is camping on the cell of the mobile relay node and the neighboring cell is also the cell of the mobile relay node.

### Supplementary Note 7

The communication control method according to any one of Supplementary Note 1 to Supplementary Note 6 further including a step of executing, by the user equipment, a cell reselection procedure by using the offset value for a mobile relay node.

Supplementary Note 8

The communication control method according to any one of Supplementary Note 1 to Supplementary Note 7 further including a step of executing, by the user equipment, an inter-frequency cell reselection procedure by using the offset value for a mobile relay node.

### Supplementary Note 9

The communication control method according to any one of Supplementary Note 1 to Supplementary Note 8 further including a step of broadcasting, by a mobile relay node, a mobile relay node cell type indication indicating that the mobile relay node itself is the mobile relay node.

### Supplementary Note 10

A communication control method to be used in a cellular communication system including: a step of receiving, by a user equipment, High-Speed Dedicated Network (HSDN) cell information indicating that a cell is an HSDN cell and a mobile relay node cell type indication indicating that the cell is a cell of a mobile relay node from the cell; and a step of executing, by the user equipment, an inter-frequency cell reselection procedure without regarding the cell as a cell of a lowest priority when the user equipment is in a low-mobility state.

### Supplementary Note 11

The communication control method according to any one of Supplementary Note 1 to Supplementary Note 10 further including
a step of receiving, by the user equipment, a frequency priority of a frequency to be used in the cell, wherein
the step of executing includes executing, by the user equipment, the inter-frequency cell reselection procedure by using the frequency priority of the cell.

Second Supplementary Note

### INTRODUCTION

A WID of a mobile IAB has been revised in RAN #97e to indicate the following objects. The detailed objects of the WI are as follows.
A migration/topology adaptation procedure that enables mobility of an IAB node including inter-donor migration (full migration) of the entire mobile IAB node is defined.
The mobile IAB node can connect to a fixed (intermediate) IAB node. Optimization specific to a scenario that a mobile IAB node connects to a stationary (intermediate) IAB node or the mobile IAB node directly connects to an IAB donor DU is prioritized lower.
Mobility of a dual-connected IAB node is prioritized lower.
Mobility of IAB nodes and UEs that receive services of the IAB nodes is enhanced including aspects relating to group mobility. No optimization for targeting at surrounding UEs is performed.

Note: The solution needs to avoid touching on a topic that has already been discussed for Rel-17 or a topic that has been excluded from Rel-17 except for enhancement of functions specific to IAB node mobility.
An interference due to mobility of an IAB node is mitigated including avoidance of potential collision between a reference signal and a control signal (a PCI, a RACH, and the like).

The following rule needs to be respected.
The mobile IAB node needs to be able to provide a service to legacy UEs.
Solutions that provide optimization for a mobile IAB may need extended functions of Rel-18 UEs but need to meet a condition that such an extended function has backward compatibility.

One of the main tasks of Rel-18 is a method of efficiently executing handover on a plurality of descendant UEs during migration of the mobile IAB node. In these supplementary notes, details of mobility enhancement for a mobile IAB will be described.

### DISCUSSION

### Enhancement of UE Mobility

### Handover Procedure of UE

RAN2 #119bis-e has reached the following agreement on the UE handover procedure.

If two logical DU cells use separate physical resources (i.e., orthogonal time and frequency resources of different carriers or the same carriers as supported in legacy L1), RAN2 focuses on a scenario that the UE recognizes the two logical DU cells as different physical cells (e.g., different PCIs of the same carriers) during full migration.

Following options O1, O2, and O3 are considered in view of QCtdoc.
1) Suspension of a message by a logical source IAB-DU by conditional streaming (e.g. at the time of MT migration),
2) Conditional execution by the UE (including CHO accompanied by a new trigger) based on, for example, a broadcast instruction such as an SIB instruction of a service time or a DCI instruction of MT migration.
3) Legacy CHO (an operation specific to implementation such as use of powering down of a source cell that triggers actual HO or powering up of a target cell) RAN2 assumes that the above O1 and O3 are likely to function, and necessity of the above O2 (such as a new trigger) needs to be further studied.

O1 is suspended from being streamed, functions in the UE according to Rel-15 and is thus regarded as a baseline. O3 having current conditional handover (CHO) functions for Rel-16 and subsequent UEs. Accordingly, whether to enhance CHO of Rel-18 based on, for example, O3 needs to be further studied.

Since there have already been feasible solutions such as O1 and O3, whether a function needs to be enhanced is questionable. On the other hand, at some point in the future, Rel-18 UEs will be a majority in a network. In this case, it may be convenient to enhance some functions for Rel-18 and subsequent UEs if there are some drawbacks to existing solutions. When a new solution is discussed, as pointed out in RAN2 #119bis-e, avoiding occurrence of a signaling storm caused by UE handover is one of the important points.

Proposal 1: RAN2 needs to discuss whether there is a problem with existing solutions for UE handover, that is, streaming suspension (O1) and CHO (O3).

In a case of O1, RRC reconfiguration accompanied by synchronization is suspended by a mobile IAB node and streamed to a UE when a mobile IAB-MT completes migration to a target donor. A timing to transmit an RRC reconfiguration message may be managed by the mobile IAB node. Accordingly, a timing to receive an RRC Reconfiguration Complete message can be controlled. Although this timing differs depending on a time during which two cells (i.e., provided by the dual DU) are maintained, part of a DL load may occur in a source cell and part of a UL load may occur in a target cell during the period.

In a case of O3, RRC reconfiguration including conditional reconfiguration is transmitted in advance by the IAB donor through the mobile IAB node. Accordingly, pre-preparation of a UE handover command is enabled, and a DL load can be dispersed in time in the source cell. On the other hand, CHO is executed when an existing event (A3/A5) is satisfied. Since O3 depends on radio states of the source/target cells (i.e. Control of transmission electrical power), the source cell and the target cell are provided from physically semi-arranged antennas.

Considering the above observation, O1 may need to hold the source cell and the target cell for a long time to reduce the DL/UL loads. O3 may cause a UL signaling storm in the target cell. Accordingly, when a new solution is introduced, these problems will be solved. That is, two cells (provided by dual DUs) need to be maintained for a minimum period of time to avoid a signaling storm.

Proposal 2: RAN2 needs to agree on that, even when the source cell and the target cell are held for a minimum period of time during migration of the mobile IAB node, if CHO is extended for Rel-18 UEs, the solution needs to avoid signaling storms in DL (source cell) and UL (target cell).

### Enhancement of Function of Cell Reselection of UE

RAN2 #119bis-e has agreed on following confirmation, observation, and assumption. RAN2 confirms that a mobile IAB needs to be associated with a legacy UE. RAN2 confirms that when the UE is camping on or connecting to the mobile IAB cell for a long period of time, the UE is likely to regard that the UE itself is camping on the mobile IAB cell (i.e. the UE needs to know that this mobile IAB cell is such a cell). Time needs to be further studied.

RAN2 makes a following assumption on the UE that operates in the mobile IAB cell.
Assumption 1: From a viewpoint of a NW of the mobile IAB cell, the principle of configuring legacy parameters (including cell (re) selection, cell reservation, and access restriction) is unchanged compared to a legacy IAB cell.
Assumption 2: A specification has no influence on an operation of the legacy UE.
Assumption 3: Newly broadcast information of R18 of the mobile IAB cell (if the agreement has been reached) does not ban/control access of the legacy UE.
Assumption 4: Non-extended UEs (including legacy UEs and R18 UEs that do not support extension) ignore the newly broadcast information of R18 of the mobile IAB cell (if the agreement has been reached).

Assumption of RAN2: Case of broadcast information of mobile IAB cell

To assist mobility in an idle/inactive mode of a Rel-18 UE, a 1-bit mobile-IAB cell type indication (or mobile relay node cell type indication) has been introduced (enabling recognition that the UE is on-board needs to be further studied).

How the 1-bit mobile-IAB cell type indication is used (the 1-bit mobile-IAB cell type indication is likely to be unique to implementation) needs to be further studied.

Although RAN2 does not specify changes for suppressing surrounding UEs from accessing the mobile IAB node from a viewpoint of a mobile IAB WI, it is thought that SA2 is working on

Rel-18 solutions that may be applicable.

Two main scenarios and several subcases where the operation of the UE is predicted are as follows.
Scenario A: A mobile IAB node is moving together with a camping UE (e.g., a train is moving).
Subcase A1: A UE (in a train or the like) needs to stay on the mobile IAB node.
Subcase A2: Surrounding UEs (outside the train or the like) should not stay on the mobile IAB node.
Scenario B: The mobile IAB node is stopping together with the camping UE (e.g., the training is stopping at a station).
Subcase B1: The UE (e.g., still in the train) needs to stay on the mobile IAB node.
Subcase B2: The UE (that is, for example, getting off the train) needs to reselect a fixed cell (such as a macrocell).
Subcase B3: Surrounding UEs (that are, for example, getting on the train) need to reselect a mobile IAB node.
Subcase B4: The surrounding UEs (e.g., still at the station) need to stay in a fixed cell.

In Subcase A1, the UE moves together with the mobile IAB node. Accordingly, RSRP and RSRQ from the mobile IAB node are always stable and keep sufficiently good quality. The cell reselection procedure is not triggered. More precisely, if the frequency priority of the mobile IAB node is higher than that outside a cell, the UE may not be able to execute intra-frequency or inter-frequency measurements, either. For example, the mobile IAB node broadcasts a priority of the frequency of the mobile IAB node as “7” or broadcasts the cell of the mobile IAB node as an HSDN cell.

It can be supposed that a train has a plurality of train compartments and the mobile IAB node is deployed in each train compartment. Even when, for example, the UE moves between the train compartments, one of the cells of the mobile IAB node is always more stable than an external macrocell when viewed from the UE in the train. A typical case is assumed where the cell of the mobile IAB node is operated at the same frequency. In this case, existing intra-frequency cell reselection, that is, the R criterion functions appropriately.

Observation 1: A mobile IAB cell that is moving is generally configured to broadcast the priority “7” of a serving frequency and/or an HSDN cell instruction and suppress cell reselection by a UE that moves together with the mobile IAB cell.

In the case of Subcases B1 and B2, an AS does not have any means to learn whether a user will remain in the train or get off the train. In this case, even when a mobile IAB node broadcasts some information, the UE cannot determine which cell, that is, which the mobile IAB node or the fixed macrocell to lastly reselect. Accordingly, which cell the UE needs to reselect finally is determined depending on a radio state and a priority of the frequency. That is, the mobile IAB node needs to undo the priority of the serving frequency set as observation 1. Hence, the mobile IAB node needs to broadcast the priority of the serving frequency. For example, broadcasting the HSDN cell instruction is stopped similar to a fixed macrocell layer.

Observation 2: When a UE and a mobile IAB node stop, the UE cannot determine whether the UE needs to reselect the mobile IAB node unless the UE knows a user's intention. That is, the determination depends on a radio wave condition.

Observation 3: A mobile IAB cell that is stopping may be typically configured to undo the frequency priority or the HSDN cell display used during movement (i.e. as in observation 1).

However, considering the above observations, one of drawbacks of the current mechanism is that an SIB of a mobile IAB node needs to be changed in response to a mobility state of the mobile IAB node. That is, observation 1 applies to the case of moving, and observation 3 applies to the case of stopping. However, this problem may not be a serious problem that needs to be solved.

Observation 4: One of drawbacks of the current mechanism is that the mobile IAB cell needs to change the mobility status thereof, i.e. an SIB between observation 1 and observation 3.

In subcase A2, according to the same logic as that of observation 1, the UE can continue camping on a fixed macrocell. That is, when the RSRP/RSRQ from the macrocell are sufficiently good, the UE does not execute intra-frequency measurement. Inter-frequency measurement at a time when the priority of the macrocell frequency is higher than the priority of the mobile IAB node or when the mobile IAB node broadcasts the HSDN cell instruction (and when the UE is not in the high-mobility state) is not performed, either.

In subcases B3 and B4, cell reselection needs to be performed in response to a radio state for the same reason as that in observation 2, and a general configuration of a fixed mobile IAB node as in observation 3 is applicable likewise.

In this regard, subcases A2, B3, and B4 indicate desirable operations for the surrounding UEs. However, it is clearly described that the WID does not perform optimization targeting at the surrounding UEs. As for subcase B3, after the UE gets on the train, subcase B1 or B2 applies, but the initial state of the UE is still the surrounding UE. Accordingly, these subcases fall outside the range of Rel-18.

Mobility of IAB Nodes and UEs that Receive Services Thereof is Enhanced Including aspects relating to group mobility. No optimization for targeting at surrounding UEs is performed.

Observation 5: Optimization for targeting at surrounding UEs is outside the range of WI, but the same configuration as those in observation 1 and observation 3 may be applicable.

In summary, an existing cell reselection mechanism, that is, a mechanism based on the radio state and the priority of the frequency still functions appropriately. Accordingly, enhancement of functions is not necessary for the UE to execute cell reselection.

Although the HSDN may be useful in subcase A1, attention needs to be paid to that the mobile IAB node can be supported without changing the specification.

Proposal 3: RAN2 needs to agree on that extension is not necessary for the UE to execute cell reselection between the UE and the mobile IAB node, that is, an assumption made by a previous conference on the “1-bit mobile IAB cell type indication” does not need to be undone.

### RACH-Less Handover of Rel-18 UE

RAN2 #119e has reached the following agreement.

R2 assumes that an RACH-less procedure may be considered for an on-board RRC CONNECTED UE to be handed over with a mobile IAB node (the procedure also depends on an assumption of UL synchronization).

In LTE, RACH-less handover is configured as follows in MobilityControlInfo using information of applicable Timing Advance (TA) and uplink grant.

Regarding a TA value at the time of RACH-less handover of the UE while migrating to an IAB node, a source cell and a target cell are provided by the same “physical”, and the UE is thus considered to apply the latest TA value and access the target cell. A “physical” distance from a DU (in this regard, via a dual “logical” DU), that is, the UE needs to be the same. Accordingly, an explicit TA value does not need to be configured for the UE. On the other hand, when RACH-less handover intends to be used for other scenarios such as handover of a mobile IAB-MT, a general approach like the LTE configuration is necessary.

Proposal 4: RAN2 needs to discuss whether the UE implicitly applies the latest TA value or explicitly configures an applicable TA value for the RACH-less handover of the UE.

Since the UE needs to transmit RRCReconfigurationComplete in UL resources granted by the target cell, UL grant information needs to be configured for the UE.

Proposal 5: RAN2 needs to agree as for RACH-less handover of the UE that UL grant information is configured by a target IAB donor CU.

Since RACH-less handover is indicated by the target IAB donor CU during a handover procedure, it can be assumed that a RACH-less configuration is included in reconfiguration WithSync in CellGroupConfig in consideration of an RRC IE structure of NR.

Proposal 6: RAN2 needs to agree on that RACH-less handover is configured by a handover command, that is, on reconfiguration accompanied by synchronization.

One question is whether RACH-less handover is also applicable to conditional handover. RAN2 #119e has agreed on that “R2 assumes that a CHO or delayed RRC configuration may be the baseline for group mobility”, and it is therefore considered to be useful to support conditional RACH-less handover.

Proposal 7: RAN2 needs to discuss whether RACH-less handover can be also configured by conditional handover, that is, the conditional reconfiguration.

### Enhancement of IAB-MT Mobility

Display of Mobile IAB Node to IAB Donor CU

RAN3 #117e has reached the following agreement.

A donor CU needs to recognize that IAB nodes are “mobile”.

In accordance with this enhancement, RAN2 #119bis-e has agreed on the following baseline.

UE function signaling is a baseline that notifies a CU of that an MT is a “mobile IAB” type. An initial mobile IAB index (e.g., message 5) needs to be further studied.

As for display of a mobility state/mode, note that for R2, a conventional report of the mobility state (e.g. mobileState-r16) can be reused and possibly a current position report from the UE can also be reused.

Rel-16 IAB intends to transmit an IAB Node indication via Msg5 for a donor to use the IAB Node indication to select an AMF that supports an IAB. Accordingly, one of the points is whether to transmit the Mobile IAB Node Indication by using Msg5 according to whether the donor needs to select the AMF that supports a MobileIAB up to RAN3.

Discussion on e-mails has pointed out that a plurality of companies can acquire real-time mobility states by a donor CU via existing measurement reports such as immediate MDT. Such mobility state information is considered to be useful for predictive mobility control. A reporter has clarified that a mobile IAB node indication is necessary for the donor to configure the mobile IAB node with an appropriate measurement configuration. However, since it is not such a big problem if the donor CU configures the mobile IAB node after receiving UE capability signaling, early notification is not justified.

Accordingly, whether an initial mobile IAB indication is necessary is up to RAN3.

Observation 6: Whether an initial mobile IAB indication of Msg5 is necessary is up to RAN3, and depends on whether, for example, the donor CU needs to select an AMF that supports the mobile IAB.

### Access Restriction of Mobile IAB Node

It is described for the WID that mobile IAB nodes provide services only to UEs.
The mobile IAB nodes must not have any descendant IAB nodes. That is, the mobile IAB nodes provide services only to UEs.

To make this requirement definite, RAN2 #119e has reached the following agreement. A method of not broadcasting “iab-Support” display is sufficient to suppress other IAB nodes from accessing the mobile IAB (has no further influence on the specification).

However, it can be also said that the agreement has been reached without sufficient discussion Regarding the part “(has no further influence on the specification)”, whether it is really sufficient to leave the method to implementation is questionable. Since the WID clearly requests that a mobile IAB node cannot access other mobile IAB nodes, it is thought that specifications need to clarify this premise to avoid confusion at the time of implementation of a mobile IAB. Accordingly, it is recommended for a stage 2 specification to obtain the above agreement or to clarify that “a mobile IAB node cannot access other mobile IAB nodes in this release”.

Proposal 8: RAN2 needs to agree to adopt the stage 2 specification in which an IAB node must not be configured in an SIB when the IAB node functions as a mobile IAB node in this release.

Another restriction has been discussed for RAN2 #119bis-e and has been regarded to be further studied as follows.

Whether to introduce that a fixed network broadcasts an indication that “a mobile IAB is supported” (whether to target at a mobile IAB MT) needs to be further studied.

A plurality of companies has pointed out that “whether an instruction from the network to the mobile IAB node is necessary may depend on whether the mobile IAB node can camp on/connect to or needs to connect to a regular IAB supporting cell”. Assuming that there is a conventional IAB donor in the network, there are three releases of IAB, and the different releases support different migration mechanisms. That is, Rel-16 supports intra-CU topology adaptation, Rel-17 supports inter-CU topology adaptation accompanied by partial migration, and Rel-18 supports inter-CU migration accompanied by full migration.

Accordingly, the mobile IAB node can technically connect with a Rel-16 donor if the mobile IAB node only moves nearby (i.e., in a cell belonging to the same donor CU), yet needs to connect with Rel-17 or Rel-17. If a Rel-18 donor moves far away (i.e., between cells belonging to different donor CUs), in other words, a previous mobile IAB node can be regarded simply as a fixed IAB node from a viewpoint of a function.

Observation 7: A mobile IAB node can connect with the Rel-16 donor if the mobile IAB node only moves nearby, yet the mobile IAB node needs to connect with a Rel-17 or Rel-18 donor if the mobile IAB node moves far away.

In this sense, although “support mobile IAB” information of a certain type needs to be broadcast by a parent node, whether a mobile IAB node can determine a cell that the mobile IAB node can connect with is questionable. Based on such a 1-bit instruction, for example, the instruction may be associated with an area in which the mobile IAB node can move. In this regard, it may also mean that the mobile IAB node needs to know an area to which the mobile IAB moves (or whether the mobile IAB is regarded as a fixed IAB node) by, for example, an OAM configuration. Whether there are other cases where a mobile IAB node can connect to a parent node that does not broadcast an indication is also worth studying. For example, the case where the mobile IAB node cannot find the parent node that broadcasts the indication. Accordingly, RAN2 needs to discuss in detail what this instruction means.

Proposal 9: RAN2 needs to agree on introduction of a “support mobile IAB” indication of a certain type. Whether the “support mobile IAB” indication is a mere 1-bit instruction and/or whether there is a condition that the mobile IAB node can access the parent node that does not broadcast the instruction need to be further studied.

1. A communication control method to be used in a cellular communication system, the communication control method comprising:
broadcasting, by a relay node, an offset value for a mobile relay node; and
executing, by a user equipment, an intra-frequency cell reselection procedure by using the offset value for a mobile relay node.

2. The communication control method according to claim 1, wherein the broadcasting comprises broadcasting, by the relay node, in response to whether the relay node is a mobile relay node or a relay node other than the mobile relay node, an offset value for a mobile relay node different from the offset value for a mobile relay node.

3. The communication control method according to claim 1, wherein the executing comprises changing, by the user equipment, a method of applying the offset value for a mobile relay node in response to whether a serving cell and a neighboring cell are a cell of a mobile relay node.

4. The communication control method according to claim 3, wherein
the changing comprises
by the user equipment,
subtracting the offset value for a mobile relay node from reference signal received power for the cell of the mobile relay node when the user equipment is camping on a cell of the relay node other than the mobile relay node and
adding the offset value for a mobile relay node to the reference signal received power for the cell of the mobile relay node when the user equipment is camping on the cell of the mobile relay node.

5. The communication control method according to claim 4, wherein the adding comprises subtracting, by the user equipment, the offset value for a mobile relay node from reference signal received power for the cell of the relay node other than the mobile relay node instead of adding the offset value for a mobile relay node.

6. The communication control method according to claim 3, wherein the changing executes, by the user equipment, the intra-frequency cell reselection procedure without using the offset value for a mobile relay node when the user equipment is camping on the cell of the mobile relay node and the neighboring cell is also the cell of the mobile relay node.

7. The communication control method according to claim 1, further comprising
executing, by the user equipment, a cell reselection procedure by using the offset value for a mobile relay node.

8. The communication control method according to claim 1, further comprising
executing, by the user equipment, an inter-frequency cell reselection procedure by using the offset value for a mobile relay node.

9. The communication control method according to claim 1, further comprising
broadcasting, by a mobile relay node, a mobile relay node cell type indication indicating that the mobile relay node itself is the mobile relay node.

10. A communication control method to be used in a cellular communication system, the communication control method comprising:
receiving, by a user equipment, High-Speed Dedicated Network (HSDN) cell information indicating that a cell is an HSDN cell and a mobile relay node cell type indication indicating that the cell is a cell of a mobile relay node from the cell; and
executing, by the user equipment, an inter-frequency cell reselection procedure without regarding the cell as a cell of a lowest priority when the user equipment is in a low-mobility state.

11. The communication control method according to claim 10, further comprising
receiving, by the user equipment, a frequency priority of a frequency to be used in the cell, wherein
the executing comprises executing, by the user equipment, the inter-frequency cell reselection procedure by using the frequency priority of the cell.

12. A user equipment comprising:
a receiver configured to receive High-Speed Dedicated Network (HSDN) cell information indicating that a cell is an HSDN cell and mobile relay node cell type information indicating that the cell is a cell of a mobile relay node from the cell; and
a controller configured to execute an inter-frequency cell reselection procedure without regarding the cell as a lowest priority when the user equipment is in a low-speed mobility state.
